(19) United States
(12) Patent Application Publication
(10) Pub. No.: US 2017/0236496 A1
(43) Pub. Date: Aug. 17, 2017

(54) VEHICULAR DISPLAY DEVICE

(71) Applicant: NIPPON SEIKI CO., LTD., Niigata (JP)

(72) Inventor: Ryuji SAITO, Niigata (JP)

(21) Appl. No.: 15/519,139

(22) PCT Filed: Oct. 13, 2015
(86) PCT No.: PCT/JP2015/078933

§ 371 Date: Apr. 13, 2017

(30) Foreign Application Priority Data
Oct. 15, 2014 (JP) 2014-210669

(51) Int. Cl. G09G 5/39; G06F 12/14; B60K 37/02

(52) U.S. Cl. CPC G09G 5/39; B60K 37/02; G06F 12/1458; B60K 2350/352; B60K 2350/307; G06F 2212/1052; G06F 2212/173; G06F 2212/202; G09G 2380/10; G09G 2310/0291; G09G 2358/00

(57) ABSTRACT

A vehicular display device includes: a display means; a control means for controlling the display of the display means; a non-volatile memory for storing at least an operation program for the control means or image data to be displayed on the display means; and a third connection terminal that can be connected with either a first connection terminal or a second connection terminal having different terminal arrangements. The vehicular display device, housed in an instrument panel of a vehicle, is provided with an external device that communicates with the control means by connecting the first connection terminal or the second connection terminal to the third connection terminal, wherein the control means determines whether over-writing of the non-volatile memory should be allowed in accordance with the type of the connection terminal connected to the third connection terminal.

### TECHNICAL FIELD

The present invention relates to a vehicular display device allowing an external device to rewrite a non-volatile memory.

### BACKGROUND ART

Conventionally, a vehicular display device mounted on a vehicle, in which image data for use in display can be rewritten by using a portable storage medium without removing the vehicular display device from the vehicle, is disclosed in PTL 1.

### CITATION LIST

### Patent Literature(s)

PTL 1: JP-A-2006-335080

### SUMMARY OF INVENTION

### Technical Problem(s)

However, in order to rewrite not only image data for use in display but also a control program for controlling display in the vehicular display device disclosed in PTL 1, it is necessary to carry out further improvement in security.

The invention has been made in view of the above problem, and an object is to improve security of a vehicular display device allowing an external device to rewrite a non-volatile memory.

### Solution to Problem(s)

A vehicular display device 1 according to the invention including

display means 10,

control means 12 for performing display control of the display means 10,

a non-volatile memory 11 storing at least an operation program of the control means 12 and image data to be displayed on the display means 10, and

a third connection terminal CN3 connectable to both a first connection terminal CN1 and a second connection terminal CN2 having different terminal arrangements,

the vehicular display device 1 being housed in an instrument panel 2 of a vehicle, comprising:

an external device 4 configured to connect the first connection terminal CN1 or the second connection terminal CN2 to the third connection terminal CN3 to communicate with the control means 12, wherein

the control means 12 switches permission/non-permission of rewriting to the non-volatile memory 11 in accordance with a type of the connection terminal connected to the third connection terminal CN3.

Further, the vehicular display device 1 according to the invention further includes:

a fourth connection terminal CN4 different from the third connection terminal CN3; and

a latch 14 configured to rewrite a permission state of rewriting to the non-volatile memory 11 via the fourth connection terminal CN4 and hold the permission state, wherein

the control means 12 switches permission/non-permission of rewriting to the non-volatile memory 11 in accordance with the state held by the latch 14 and the type of the connection terminal connected to the third connection terminal CN3.

Further, in the vehicular display device 1 according to the invention,

the control means 12 communicates diagnosis information to the external device 4 via the fourth connection terminal CN4, and

the latch 14 allows the external device 4 to rewrite the permission state of rewriting to the non-volatile memory 11 via the control means 12.

Further, in the vehicular display device 1 according to the invention,

when the control means 12 performs communication with a communication method in which, when the control means 12 communicates with the external device 4, one of the control means 12 and the external device 4 serves as a master and performs control and the other one of the control means 12 and the external device 4 performs operation in accordance with control by the one of the control means 12 and the external device 4, and

the control means 12 communicates with the external device 4 while switching master/slave of the control means 12 in accordance with the type of the connection terminal connected to the third connection terminal CN3.

Further, in the vehicular display device 1 according to the invention,

the control means 12 supplies power to the external device 4 via the third connection terminal CN3.

Further, in the vehicular display device 1 according to the invention,

the control means 12 switches permission/non-permission of rewriting to the non-volatile memory 11 in accordance with the type of the connection terminal connected to the third connection terminal CN3 when the control means 12 returns from reset.

### Advantageous Effects of Invention

According to the invention, security of a vehicular display device allowing an external device to rewrite a non-volatile memory is improved.

### BRIEF DESCRIPTION OF DRAWINGS

FIG. 1 is a front view of a vehicular display device that is a first embodiment of the invention.

FIG. 2 shows an external device to be connected to the same embodiment.

FIG. 3 shows an electrical configuration of the same embodiment.

FIG. 4 shows a connection terminal arrangement of an external device to be connected to the same embodiment.

FIG. 5 shows a control procedure of the same embodiment.

FIG. 6 shows an electrical configuration of a second embodiment of the invention.

FIG. 7 shows an external device to be connected to the same embodiment.

FIG. 8 shows a control procedure of the same embodiment.

### DESCRIPTION OF EMBODIMENTS

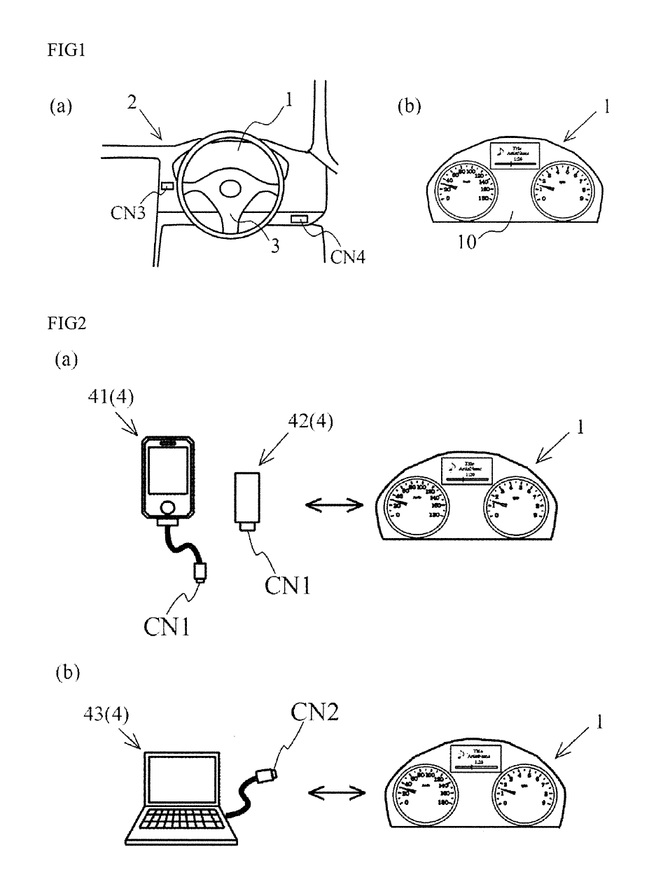

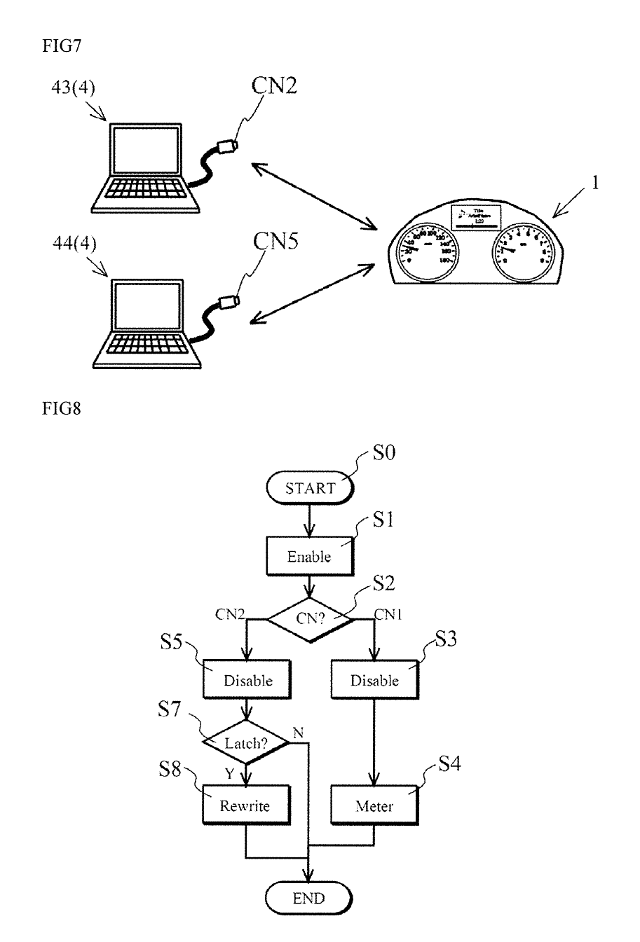

Hereinafter, embodiments in which the invention is applied to a vehicular display device mounted on a vehicle will be described with reference to FIG. 1 to FIG. 8.

### First Embodiment

As shown in FIG. 1, a vehicular display device 1 that is a first embodiment to which the invention is applied is incorporated into an instrument panel 2 of a vehicle so as to be visually recognized while a steering 3 is being operated. A pointer instrument having an indicator including a scale and numbers for indicating measurement values such as driving speed and engine rpm of the vehicle and a pointer indicating the indicator is displayed on display means 10 of the vehicular display device 1.

The vehicular display device 1 includes the display means 10, a non-volatile memory 11, control means 12, and a connector (third connection terminal) CN3 and is electrically connected to a reset switch SW for resetting the control means 12 and vehicle information input means LAN for inputting a measurement value. The connector CN3 is exposed from the instrument panel 2 and can be connected to an external device 4.

The vehicle information input means LAN is made up of, for example, a CAN (Controller Area Network) and is a communication channel for mutually communicating with another in-vehicle device by connecting a cable to a connector (not shown) included in the vehicular display device 1.

The display means 10 is, for example, a liquid crystal display or organic EL display and displays an image in accordance with control by the control means 12.

The non-volatile memory 11 is, for example, a memory capable of holding memory even while power is not being supplied, such as a flash memory. A control program of the control means 12 and image data to be displayed on the display means 10 described below are stored in advance on the non-volatile memory 11, and data is read and written as appropriate in accordance with control by the control means 12.

The control means 12 is, for example, a microcomputer. When a reset signal is input to a terminal 121 by pushing the reset switch SW, the control means 12 reads the control program stored on the non-volatile memory 11 and starts. When the control means 12 starts, the control means 12 forms an instrument image indicating a measurement value input via the vehicle information input means LAN with the use of the image data stored on the non-volatile memory 11 and displays the instrument image on the display means 10.

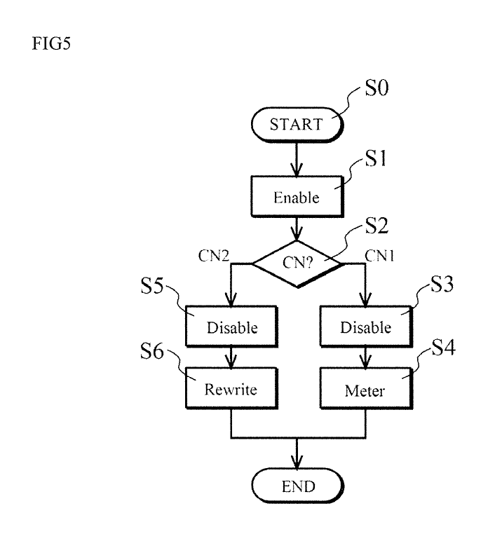

The connector CN3 includes terminals P1 to P5 and is configured to be connected to both a connector (first connection terminal) CN1 and a connector (second connection terminal) CN2 configured by terminal arrangements shown in FIG. 4.

A logic circuit 13 including a three-state inverter 131 and three-state buffers 132 and 133 is provided between the terminal P4 of the connector CN3 and the control means 12, and the control means 12 determines a type of a connector connected to the connector CN3 via the logic circuit 13.

When the external device 4 is connected to the connector CN3, the control means 12 performs mutual communication with a differential transmission method using the terminal P2 and the terminal P3 while one of the control means 12 and the external device 4 is serving as a master and the other one thereof is serving as a slave.

When the external device 4 is connected to the connector CN3 via the connector (first connection terminal) CN1 described below, the control means 12 mutually communicates with the external device 4 while the control means 12 itself is serving as a master. The external device 4 to be connected via the connector CN1 is, for example, a multifunction mobile phone 41 capable of updating various applications or a portable non-volatile memory 42. The connector CN1 may be included in the external device 4, or a cable including the connector CN1 or a conversion connector may be inserted. The control means 12 may obtain a content from the external device 4. For example, the control means 12 displays music information reproduced by the multifunction mobile phone 41 on the display means 10 or displays map information acquired by the multifunction mobile phone 41 on the display means 10, or the control means 12 reproduces music information stored on the portable non-volatile memory 42 and displays the music information on the display means 10. Alternatively, the control means 12 may provide a content to the external device 4 so that the driving speed and the engine rpm of the vehicle are input from the control means 12 to the external device 4 and are displayed on a display screen of the external device 4. Further, the control means 12 supplies power to the external device 4 connected via the connector CN1 through a terminal 122 and the terminal P1 of the connector CN3.

When the external device 4 is connected to the connector CN3 via the connector (second connection terminal) CN2 described below, the control means 12 mutually communicates with the external device 4 while the control means 12 itself is serving as a slave. The control means 12 rewrites the control program and image data stored on the non-volatile memory 11 in response to input from the external device 4. The external device 4 to be connected via the connector CN2 is, for example, a portable computer storing a program for rewriting the control program of the vehicular display device 1, and, in a case where the control program of the vehicular display device 1 is defective, the external device 4 is used to overwrite a correction program to the vehicular display device 1 by a dealer or the like. Further, the connector CN2 may be included in the external device 4, or a cable including the connector CN2 or a conversion connector may be inserted.

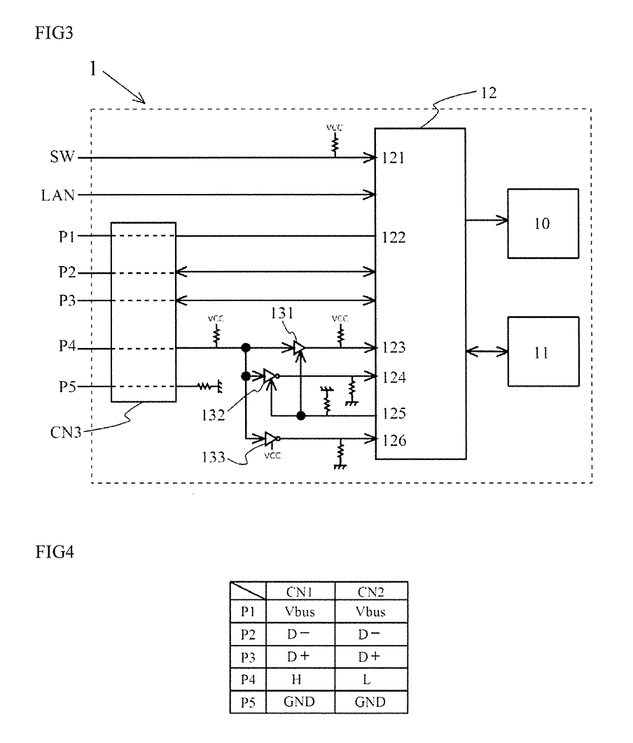

A control procedure of the control means 12 will be described with reference to FIG. 3 to FIG. 5.

### (Step S0)

When a reset signal is input to the terminal 121 and reset is performed, the control means 12 reads the control program stored on the non-volatile memory 11 and starts.

### (Step S1)

The control means 12 enables the three-state inverter 131 and the three-state buffer 132 via a terminal 125, and the processing proceeds to Step S2.

### (Step S2)

The control means 12 determines whether or not an external device including the connector CN2 is connected to the connector CN3 on the basis of a state of signals input to a terminal 123 and a terminal 124. When the connector CN1 is connected, a positive logic (voltage close to power supply voltage) H is input to the terminal P4 of the connector CN3, and, when the connector CN2 is connected, a negative logic (voltage close to zero voltage) L is input thereto, and, as shown in FIG. 3, the state of signals input to the terminal 123 and the terminal 124 is such that the positive logic H is input to a terminal 116 and the negative logic L is input to a terminal 117 while the three-state inverter 131 and the three-state buffer 132 are in a disabled state. In a case where the external device including the connector CN2 is not connected to the connector CN3 (the external device 4 including the connector CN1 is connected to the connector CN3 or nothing is connected to the connector CN3) while the three-state inverter 131 and the three-state buffer 132 are in an enabled state, the positive logic H is input to the terminal 123 and the negative logic L is input to the terminal 124, which is similar to the period in which the three-state inverter 131 and the three-state buffer 132 are in the disabled state. Meanwhile, when the external device including the connector CN2 is connected to the connector CN3 while the three-state inverter 131 and the three-state buffer 132 are in the enabled state, the negative logic L is input to the terminal 123 and the positive logic H is input to the terminal 124. With this, the control means 12 determines whether or not the external device including the connector CN2 is connected to the connector CN3, and, in a case where the external device including the connector CN2 is connected to the connector CN3 (Step S2: CN2), the processing proceeds to Step S5, and, if not (Step S2: CN1), the processing proceeds to Step S3.

### (Step S3)

The control means 12 disables the three-state inverter 131 and the three-state buffer 132 via the terminal 125, and the processing proceeds to Step S4.

### (Step S4)

The control means 12 displays, on the display means 10, a measurement value input via the vehicle information input means LAN as an instrument image. Further, when external devices 41 and 42 are connected, the control means 12 starts communication and displays, on the display means 10, contents input from the external devices 41 and 42 together with the instrument image.

### (Step S5)

The control means 12 disables the three-state inverter 131 and the three-state buffer 132 via the terminal 125, and the processing proceeds to Step S6.

### (Step S6)

When an external device 43 is connected, the control means 12 rewrites content of the non-volatile memory 11 on the basis of data input from the external device 43 while the control means 12 itself is serving as a slave. Further, while the content of the non-volatile memory 11 is being rewritten, the control means 12 displays a message that rewriting to the non-volatile memory 11 is currently performed and a state of progress thereof on the display means 10, and, when the rewriting of the content of the non-volatile memory 11 is completed, the control means 12 displays, on the display means 10, a message to urge that the rewriting be completed, the control means 12 be reset, and re-start thereof be performed.

Hereinabove, a configuration of the first embodiment has been described. With this configuration, rewriting of the control program and image data stored on the non-volatile memory 11 can be switched in accordance with types of the connectors CN1 and CN2 connected to the connector CN3. Therefore, it is possible to use a common connector at normal use (at the time of instrument display) and at the time of rewriting the control program and image data stored on the non-volatile memory 11, and it is also possible to determine the time of rewriting the control program and image data stored on the non-volatile memory 11 and switch permission/non-permission of access to the non-volatile memory 11. Thus, security is improved.

### Second Embodiment

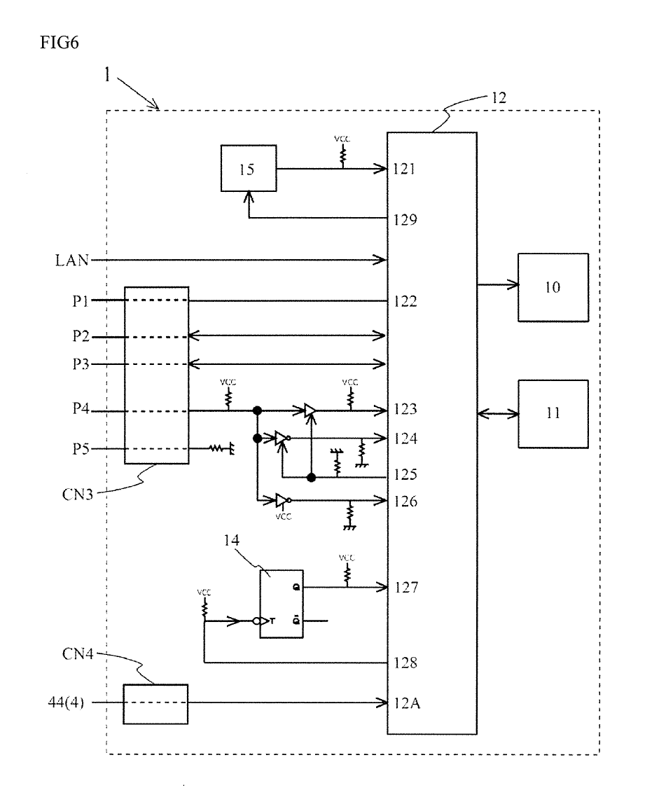

Further, as shown in FIG. 6, the vehicular display device 1 that is a second embodiment to which the invention is applied includes a connector (fourth connection terminal) CN4, a latch 14, and a reset IC 15 in addition to the configuration of the first embodiment.

The latch 14 is a latch circuit capable of holding information of one bit and holds a state in which writing to the non-volatile memory 11 is permitted/not permitted. The latch 14 may be a flip-flop circuit or the like as long as the latch can hold the state in which writing to the non-volatile memory 11 is permitted/not permitted.

The reset IC 15 is made up of, for example, a voltage detector including a voltage detecting device and outputs a reset signal to the terminal 121 in accordance with an output voltage of a terminal 129 of the control means 12. The reset IC 15 preferably includes a delay circuit.

The connector CN4 positions on, for example, a lower right or left side under the steering 3 on a back surface of the instrument panel 2 and is connected to an external device 44 for acquiring various kinds of diagnosis information from a diagnosis information function (OBD: On-Board Diagnostics) of the vehicle. The external device 44 is, for example, a portable computer and includes a connector (fifth connection terminal) CN5 connectable to the connector CN4 and is connected to the connector CN4 or is connected to the connector CN4 via a cable including the connector CN2 or a conversion connector.

The control means 12 has the diagnosis information function of the vehicle, and, when the external device 44 is connected, outputs various kinds of diagnosis information to the external device 44. The control means 12 can rewrite information of the latch 14 to information indicating that writing to the non-volatile memory 11 is permitted in accordance with control by the external device 44. Further, the control means 12 controls output of the terminal 129 to cause the reset IC 15 to output a reset signal in accordance with a request from the external device 44, thereby resetting the control means itself.

In a control procedure of the control means 12 in the second embodiment, Step S7 and Step S8 are performed, instead of Step S6 in the control procedure of the first embodiment.

The control procedure of the control means 12 will be described with reference to FIG. 8 in order from Step S7.

### (Step S7)

After Step S5 is completed, in a case where a state stored on the latch 14 is permission of writing to the non-volatile memory 11 (Step S7: Y), the processing proceeds to Step S8, and, if not (Step S7N), the control means 12 displays, on the display means 10, a message indicating that writing to the non-volatile memory 11 is not permitted and completes the procedure.

### (Step S8)

The control means 12 rewrites content of the non-volatile memory 11 on the basis of data input from the external device 43 while the control means 12 itself is serving as a slave. Further, while the content of the non-volatile memory 11 is being rewritten, the control means 12 displays a message that rewriting to the non-volatile memory 11 is currently performed and a state of progress thereof on the display means 10, and, when the rewriting of the content of the non-volatile memory 11 is completed, the control means 12 displays, on the display means 10, a message to urge that the rewriting be completed, the control means 12 be reset, and re-start thereof be performed and stores, on the latch 14, a state in which writing to the non-volatile memory 11 is not permitted.

Hereinabove, a configuration of the second embodiment has been described. With this configuration, even in a case where the external device 4 including the connector CN1 is connected to the connector CN3, the content of the non-volatile memory 11 cannot be rewritten unless a state stored on the latch 14 is rewritten to permission of writing to the non-volatile memory 11 via the connector CN4 that is different from the connector CN3. Thus, security is improved. Further, by using the connector CN4 also as a connector for transmitting diagnosis information of the vehicle, the connector being a connector that the vehicular display device should include, it is possible to improve security without increasing the number of connectors.

Hereinabove, the first embodiment and the second embodiment to which the invention is applied have been described. However, the invention is not limited thereto, and, also in other configurations, various modifications and design alterations can be performed within the scope of the invention.

For example, in the second embodiment, content of the latch 14 can be rewritten by the external device 44 for acquiring various diagnosis information from the diagnosis information function (OBD: On-Board Diagnostics) of the vehicle. However, the invention is not limited thereto, and the content may be configured to be rewritten via the vehicle information input means LAN.

Further, the vehicular display device 1 is connected to a battery of the vehicle and therefore power is stably supplied, and thus it is preferable that the control means 12 supply power to the external device 43 for performing writing to the non-volatile memory 11 so as to reduce a possibility that the external device 43 is short of power while performing rewriting processing on the non-volatile memory 11 and the rewriting processing is interrupted.

### INDUSTRIAL APPLICABILITY

The invention is suitable for a vehicular display device to be mounted on a vehicle.

### REFERENCE SIGNS LIST

1: vehicular display device
10: display means
11: non-volatile memory
12: control means
13: logic circuit
14: latch
15: reset IC
2: instrument panel
3: steering
4: external device
CN1: connector (first connection terminal)
CN2: connector (second connection terminal)
CN3: connector (third connection terminal)
CN4: connector (fourth connection terminal)
LAN: vehicle information acquiring means
SW: reset switch

1. A vehicular display device including
display means,
control means for performing display control of the display means,
a non-volatile memory storing at least an operation program of the control means and image data to be displayed on the display means, and
a third connection terminal connectable to both a first connection terminal and a second connection terminal having different terminal arrangements,
the vehicular display device being housed in an instrument panel of a vehicle, comprising:
an external device configured to connect the first connection terminal or the second connection terminal to the third connection terminal to communicate with the control means, wherein
the control means switches permission/non-permission of rewriting to the non-volatile memory in accordance with a type of the connection terminal connected to the third connection terminal.

2. The vehicular display device according to claim 1, further comprising:
a fourth connection terminal different from the third connection terminal; and
a latch configured to rewrite a permission state of rewriting to the non-volatile memory via the fourth connection terminal and hold the permission state, wherein
the control means switches permission/non-permission of rewriting to the non-volatile memory in accordance with the state held by the latch and the type of the connection terminal connected to the third connection terminal.

3. The vehicular display device according to claim 2, wherein:
the control means communicates diagnosis information to the external device via the fourth connection terminal; and
the latch allows the external device to rewrite the permission state of rewriting to the non-volatile memory via the control means.

4. The vehicular display device according to claim 1, wherein:
when the control means performs communication with a communication method in which, when the control means communicates with the external device, one of the control means and the external device serves as a master and performs control and the other one of the control means and the external device performs operation in accordance with control by the one of the control means and the external device; and
the control means communicates with the external device while switching master/slave of the control means in accordance with the type of the connection terminal connected to the third connection terminal.

5. The vehicular display device according to claim 4, wherein
the control means supplies power to the external device via the third connection terminal.

6. The vehicular display device according to claim 1, wherein
the control means switches permission/non-permission of rewriting to the non-volatile memory in accordance with the type of the connection terminal connected to the third connection terminal when the control means returns from reset.
